(19) United States
(12) Patent Application Publication
(10) Pub. No.: US 2025/0286082 A1
(43) Pub. Date: Sep. 11, 2025

(54) Electrodes For Microbial Fuel Cells, Microbial Fuel Cell, And Microbial Fuel Cell System

(71) Applicant: SEIKO EPSON CORPORATION, Tokyo (JP)

(72) Inventor: Yohei YAMADA, Chino (JP)

(21) Appl. No.: 19/070,890

(22) Filed: Mar. 5, 2025

(30) Foreign Application Priority Data
Mar. 6, 2024 (JP) 2024-033663

(51) Int. Cl. H01M 4/86; H01M 8/10; H01M 8/1004; H01M 8/16

(52) U.S. Cl. CPC H01M 4/8657; H01M 4/8668; H01M 4/8673; H01M 8/1004; H01M 8/16; H01M 2008/1095

(57) ABSTRACT

A electrode for MFCs includes: a non-conductive fiber; a conductive material having conductivity; and a binder configured to bind the conductive material to the fiber.

The present application is based on, and claims priority from JP Application Serial Number 2024-033663, filed Mar. 6, 2024, the disclosure of which is hereby incorporated by reference herein in its entirety.

### BACKGROUND

### 1. Technical Field

The present disclosure relates to electrodes for microbial fuel cells (MFCs), a microbial fuel cell (MFC), and a MFC system.

### 2. Related Art

MFCs that utilize metabolic capabilities of microorganisms are known. The MFC described in JP-A-2017-117584 includes a negative electrode, a hydrogen ion transfer layer, and a positive electrode. The negative electrode is formed of a conductive sheet having conductivity. The conductive sheet may be a metal plate or a graphite sheet having a through hole. The positive electrode includes a graphite sheet, a filter layer, and a water-repellent layer.

The graphite sheet used in the negative or positive electrode has insufficient electrical properties as an electrode.

### SUMMARY

A electrodes for MFCs according to the present disclosure includes: a non-conductive fiber; a conductive material having conductivity; and a binder configured to bind the conductive material to the fiber.

A MFC according to the present disclosure is a MFC in contact with a liquid containing an organic substance and an electrochemically active bacterium, including: an anode electrode containing a non-conductive fiber, a conductive material having conductivity, and a binder configured to bind the conductive material to the fiber; and a cathode electrode having conductivity.

A MFC system according to the present disclosure includes: a MFC including an anode electrode to be in contact with a liquid containing an organic substance and an electrochemically active bacterium, a cathode electrode to which oxygen is supplied, and a proton exchange membrane (PEM) disposed between the anode electrode and the cathode electrode; and a resistor coupled to the anode electrode and the cathode electrode. The anode electrode contains a non-conductive fiber, a conductive material having conductivity, and a binder configured to bind the conductive material to the fiber.

### BRIEF DESCRIPTION OF THE DRAWINGS

FIG. 1 is a diagram showing a schematic configuration of a MFC system.

FIG. 2 is a diagram showing an example of a configuration of an anode electrode.

FIG. 3 is a diagram showing an example of the configuration of the anode electrode.

FIG. 4 is a diagram showing an example of the configuration of the anode electrode.

FIG. 5 is a diagram showing a schematic configuration of a cathode electrode.

FIG. 6 is a diagram showing an example of a configuration of the cathode electrode.

FIG. 7 is a diagram showing a configuration of a MFC.

FIG. 8 is a diagram showing an evaluation result of the MFC.

FIG. 9 is a diagram showing the evaluation result of the MFC.

FIG. 10 is a diagram showing the evaluation result of the MFC.

FIG. 11 is a diagram showing the evaluation result of the MFC.

FIG. 12 is a diagram showing the evaluation result of the MFC.

### DESCRIPTION OF EMBODIMENTS

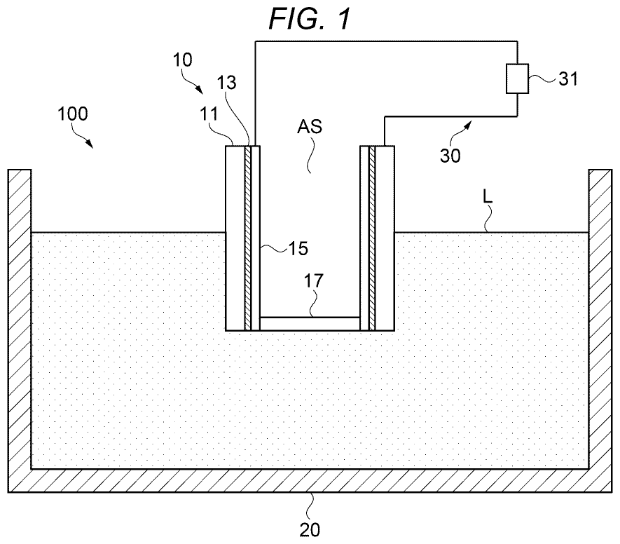

FIG. 1 shows a schematic configuration of a MFC system 100. The MFC system 100 decomposes organic substances contained in a organic wastewater L using microorganisms. The MFC system 100 produces energy, useful substances, and the like by electrochemically controlling metabolism of the microorganisms. The MFC system 100 includes a MFC 10, an accommodation container 20, and an external circuit 30. The accommodation container 20 accommodates the organic wastewater L containing organic substances and microorganisms.

The MFC 10 converts the organic substance, which is a fuel, into electric energy using the microorganisms. The MFC 10 is immersed in the organic wastewater L accommodated in the accommodation container 20. The MFC 10 includes an anode electrode 11, a PEM 13, a cathode electrode 15, and a shielding member 17.

The anode electrode 11 collects electrons generated when the organic substance in the organic wastewater L is oxidized and decomposed by the microorganism. The electrons collected by the anode electrode 11 move to the cathode electrode 15 via the external circuit 30. The anode electrode 11 is in contact with the organic wastewater L accommodated in the accommodation container 20. On the anode electrode 11, the microorganism contained in the organic wastewater L decomposes the organic substance to generate electrons and hydrogen ions. Electrons generated by the microorganisms are collected by the anode electrode 11. The anode electrode 11 includes fiber bodies 111, conductive materials 113, and binding materials 115. A detailed configuration of the anode electrode 11 will be described later. The anode electrode 11 corresponds to an example of a electrodes for MFCs.

The anode electrode 11 is formed in a hollow cylindrical shape. The anode electrode 11 may have a columnar shape or a quadrangular prism shape. The anode electrode 11 may be constituted by one member or may be constituted by combining a plurality of members. An outer peripheral surface of the anode electrode 11 is in contact with the organic wastewater L and carries the microorganism in the organic wastewater L.

The PEM 13 allows hydrogen ions generated when a microorganism decomposes an organic substance to pass therethrough. The PEM 13 has a function of moving the hydrogen ions from the anode electrode 11 to the cathode electrode 15.

The PEM 13 is disposed on an inner peripheral surface of the anode electrode 11. The PEM 13 is formed in a hollow cylindrical shape. An outer peripheral surface of the PEM 13 is in contact with the inner peripheral surface of the anode electrode 11. The inner peripheral surface of the PEM 13 is in contact with the cathode electrode 15. The PEM 13 is disposed between the anode electrode 11 and the cathode electrode 15, and separates the anode electrode 11 from the cathode electrode 15.

The PEM 13 is made of, for example, an ion exchange resin. The ion exchange resin includes NAFION manufactured by DuPont Kabushiki Kaisha, FLEMION manufactured by AGC Inc., and SELEMION manufactured by AGC Inc. NAFION, FLEMION, and SELEMION are registered trademarks.

The PEM 13 may be formed of a porous membrane having pores through which hydrogen ions permeate. The PEM 13 includes a porous sheet, a woven fabric sheet, and a nonwoven fabric sheet. The PEM 13 is preferably a sheet material containing a non-conductive fiber material, wood powder particles, and an adhesive for bonding the fiber material to the wood powder particles. The fiber material may be the same as or different from the fiber body 111 included in the anode electrode 11. The fiber material is preferably the same material as the fiber body 111. Since the fiber material is the same material as the fiber body 111, adhesion between the anode electrode 11 and the PEM 13 is improved.

The cathode electrode 15 consumes electrons moving through the external circuit 30 in a reduction reaction of an oxidant. The electrons flow in the external circuit 30 according to a gradient of a potential generated in the anode electrode 11 and an oxidation-reduction potential of a chemical reaction generated in the cathode electrode 15. The cathode electrode 15 uses oxygen in an atmosphere as an oxidant. Oxygen moves in the cathode electrode 15. Oxygen reacts with hydrogen ions moving in the PEM 13.

The cathode electrode 15 is formed in a hollow cylindrical shape. An ion exchange surface 15a, which is an outer peripheral surface of the cathode electrode 15, is in contact with the inner peripheral surface of the PEM 13 directly or via another member. An oxygen-permeable surface 15b, which is an inner peripheral surface of the cathode electrode 15, is in contact with the atmosphere in an atmospheric space AS. The atmospheric space AS is formed in an inner peripheral portion of the cathode electrode 15. The oxygen-permeable surface 15b allows oxygen in the atmosphere to permeate through the cathode electrode 15. Oxygen is supplied to the cathode electrode 15. The configuration of the cathode electrode 15 will be described later.

The shielding member 17 is disposed at one end of the oxygen-permeable surface 15b. The shielding member 17 prevents the organic wastewater L from flowing into the atmospheric space AS. The form of the shielding member 17 is not limited as long as the organic wastewater L is prevented from flowing into the atmospheric space AS.

The accommodation container 20 accommodates the organic wastewater L. The accommodation container 20 may be coupled to an inflow path and an outflow path. The inflow path is a path through which the organic wastewater L flows into the accommodation container 20. The outflow path is a path through which the organic wastewater L flows out from the accommodation container 20. The inflow path and the outflow path are not shown. The MFC system 100 shown in FIG. 1 includes the accommodation container 20, and is not limited thereto. The accommodation container 20 may not be provided. When the accommodation container 20 is not provided, the MFC 10 is disposed in a lake, a river, or the like.

The organic wastewater L contains the organic substance and the microorganism. The organic wastewater L is, for example, water collected from lakes or rivers. The organic wastewater L may be water or living wastewater containing organic mud collected from lakes or the like. The organic substance in the organic wastewater L is consumed as a fuel of the microorganism.

The microorganisms are electrochemically active bacteria that decompose the organic substance in the organic wastewater L. The electrochemically active bacteria include Geobacter bacteria, Shewanella bacteria, Aeromonas bacteria, Geothrix bacteria, and Saccharomyces bacteria. The microorganisms may be contained in the organic wastewater L in advance, or may be added to the organic wastewater L. The microorganisms may be supported by the anode electrode 11 with a biofilm or the like.

The external circuit 30 is an electric circuit that moves electrons from the anode electrode 11 to the cathode electrode 15. The external circuit 30 is electrically coupled to the anode electrode 11 and the cathode electrode 15. The external circuit 30 includes a resistor 31. The resistor 31 is coupled to the anode electrode 11 and the cathode electrode 15. The resistor 31 may be a variable resistor for which a resistance value is switched. The resistor 31 adjusts an amount of current flowing through the external circuit 30.

In the MFC 10 shown in FIG. 1, the anode electrode 11, the PEM 13, and the cathode electrode 15 are integrally formed, and the present disclosure is not limited thereto. The anode electrode 11, the PEM 13, and the cathode electrode 15 may be separately formed. The anode electrode 11, the PEM 13, and the cathode electrode 15 are each immersed in the organic wastewater L.

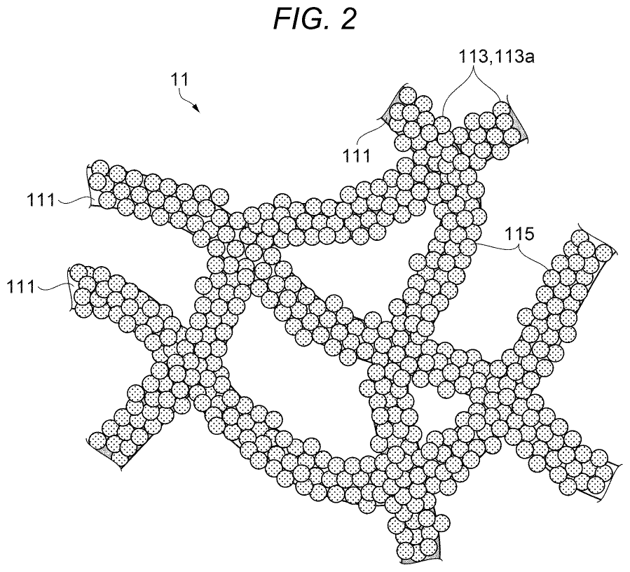

FIG. 2 shows an example of the configuration of the anode electrode 11. FIG. 2 schematically shows an enlarged configuration of a part of the anode electrode 11. The anode electrode 11 shown in FIG. 2 includes the fiber body 111, a conductive powder 113a as an example of the conductive material 113, and the binding material 115.

The fiber body 111 is made of a non-conductive material. The fiber body 111 carries the conductive powder 113a. Since the anode electrode 11 includes the fiber bodies 111, the number of holes in the anode electrode 11 increases. As the number of holes increases, a surface area of the anode electrode 11 increases. As the surface area of the anode electrode 11 increases, the number of sites where electrons are transferred by a microorganism increases. The fiber body 111 is, for example, a defibrated fiber defibrated by a dry fiber technology. The defibrated fibers include cellulose fibers obtained by defibrating waste paper, plant fibers obtained by defibrating plants such as eucalyptus, and the like. The fiber body 111 has a fiber diameter of 20 μm to 100 μm and a fiber length of 0.5 mm to 100 mm. The fiber bodies 111 are bonded to each other by the binding material 115. The fiber body 111 is preferably made of an organic material. When the fiber body 111 is eluted into the organic wastewater L due to deterioration or the like, the eluted fiber body 111 is consumed as a fuel of a microorganism. The fiber body 111 corresponds to an example of a fiber.

The conductive powder 113a has conductivity. The conductive powder 113a contributes to the conductivity of the anode electrode 11. The conductive powder 113a is bonded to a surface of the fiber body 111 by the binding material 115. A plurality of conductive powders 113a are in contact with each other and bonded onto the fiber body 111. The plurality of conductive powders 113a are disposed in contact with each other, thereby imparting the conductivity to the fiber body 111. The conductive powder 113a is disposed in a single layer or a multiple layer on the fiber body 111. The conductive powder 113a is preferably disposed in a multiple layer on the fiber body 111. When the conductive powder 113a on an outermost surface falls off as a result of the conductive powder 113a being disposed in the multiple layer, fresh conductive powder 113a is deposited on the surface. Since the fresh conductive powder 113a is deposited on the surface, durability of the MFC 10 is improved.

The conductive powder 113a is formed of graphite particles, carbon black particles, or the like. The conductive powder 113a is a powder having an average particle diameter of 0.1 μm to 500 μm on a volume basis. The conductive powder 113a is formed of one or a plurality of types of powders. The material of the conductive powder 113a is not limited as long as the conductive powder 113a has a property of imparting conductivity to the fiber body 111.

A content of the conductive powder 113a is preferably 50 mass % or more and 80 mass % or less in terms of a mass ratio of the anode electrode 11. When the content of the conductive powder 113a is less than 50 mass %, an electric resistance of the anode electrode 11 increases, and a function as an electrode deteriorates. When the content of the conductive powder 113a is more than 80 mass %, holes in the anode electrode 11 are reduced.

The binding material 115 binds the conductive powder 113a to the fiber body 111. The conductive powder 113a is bonded to the surface of the fiber body 111 by the binding material 115. The binding material 115 binds the plurality of fiber bodies 111 to each other. The plurality of fiber bodies 111 are bonded to each other by the binding material 115. The binding material 115 binds the plurality of conductive powders 113a to each other. Due to the binding material 115, the plurality of conductive powders 113a are formed in one or more layers on the fiber body 111.

The material of the binding material 115 is not limited as long as the fiber body 111 and the conductive powder 113a can be bonded. The binding material 115 may be a solid material or a liquid material at a room temperature. The binding material 115 preferably contains at least one of calcium carbonate, a lignin powder, and a starch powder. The binding material 115 contains at least one of calcium carbonate, a lignin powder (average particle diameter of 26 μm to 70 μm on a volume basis), and a starch powder (average particle diameter of 1 μm to 30 μm on a volume basis), thereby reducing an environmental impact when producing the anode electrode 11. In addition, a binding force when bonding the plurality of conductive powders 113a is made to be relatively small. When the conductive powder 113a is formed of multiple layers, the outermost conductive powder 113a is likely to fall off. When the outermost conductive powder 113a falls off, the fresh conductive powder 113a is exposed. The binding material 115 may be a waxy substance produced from resource organisms such as scale insects. The binding material 115 corresponds to an example of a binder.

The content of the binding material 115 is preferably 5 mass % or more and 30 mass % or less in terms of the mass ratio of the anode electrode 11. When the content of the binding material 115 is less than 5 mass %, the binding force of the conductive powder 113a to be bonded onto the fiber body 111 decreases. It is difficult to maintain a shape of the anode electrode 11. When the content of the binding material 115 is more than 30 mass %, the amount of the binding material 115 disposed between the plurality of conductive powders 113a increases, and the electric resistance increases. Electrical properties of the anode electrode 11 deteriorate.

The anode electrode 11 includes the non-conductive fiber bodies 111, the conductive materials 113 having conductivity, and the binding materials 115 that bonds the conductive materials 113 to the fiber bodies 111.

Since the anode electrode 11 includes the fiber bodies 111, the conductive materials 113, and the binding materials 115, the number of sites where electrons are moved by the microorganism increases. Electrical properties of the anode electrode 11 are improved.

The binding material 115 preferably contains at least one of calcium carbonate, a lignin powder, and a starch powder.

When the binding material 115 contains at least one of the calcium carbonate, the lignin powder, and the starch powder, an environmental load when the anode electrode 11 is generated is reduced.

The content of the fiber body 111 in the anode electrode 11 is a remaining amount excluding the conductive powder 113a and the binding material 115. The anode electrode 11 may contain an additive other than the fiber bodies 111, the conductive powders 113a, and the binding materials 115. When the anode electrode 11 includes an additive other than the fiber bodies 111, the conductive powders 113a, and the binding materials 115, the content of the fiber bodies 111 in the anode electrode 11 is a remaining amount excluding the conductive powders 113a, the binding materials 115, and the additive.

The anode electrode 11 is produced using the fiber bodies 111, the conductive powders 113a, and the binding materials 115. A producer mixes the fiber bodies 111 and the binding materials 115 at a predetermined mass ratio to produce a mixture. In the mixture, the binding materials 115 adhere to the surfaces of the fiber bodies 111. After producing the mixture, the producer adds the conductive powder 113a to the mixture and mixes them again. The producer generates an electrode mixture including the fiber body 111, the conductive powder 113a, and the binding material 115. The producer applies heat and pressure to the electrode mixture in a predetermined mold to produce a solid body. The applied pressure is in a range of 1 kN/mm² or more and 20 kN/mm² or less. A heating temperature is in a range of 80° C. or higher and 150° C. or lower. The applied pressure and the heating temperature are appropriately adjusted according to addition amounts of the conductive powder 113a and the binding material 115. The producer processes the solid body into a desired shape to produce the anode electrode 11. The anode electrode 11 is a compact including holes.

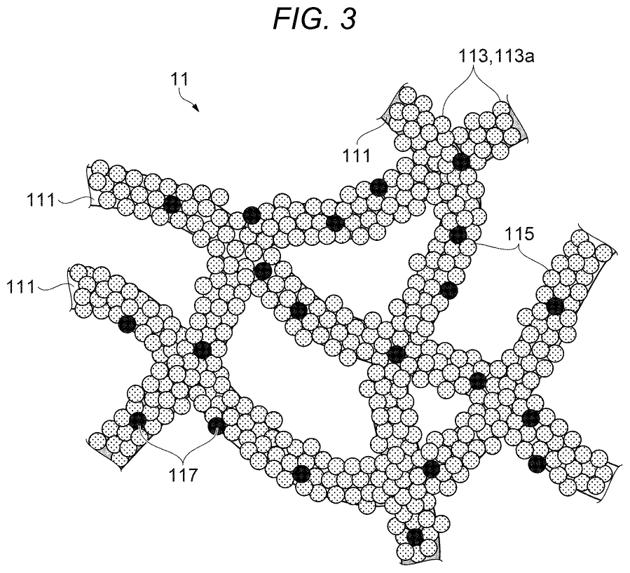

FIG. 3 shows an example of the configuration of the anode electrode 11. FIG. 3 schematically shows an enlarged configuration of a part of the anode electrode 11. The anode electrode 11 shown in FIG. 3 includes the fiber bodies 111, the conductive powders 113a, the binding materials 115, and zero-valent iron particles 117. The anode electrode 11 shown in FIG. 3 has a configuration same as that of the anode electrode 11 shown in FIG. 2 except that the anode electrode contains zero-valent iron particles 117.

The anode electrode 11 shown in FIG. 3 contains the zero-valent iron particles 117. The zero-valent iron particles 117 have conductivity. The zero-valent iron particles 117 are iron powders. The zero-valent iron particles 117 are added when the conductive powder 113a are mixed into the mixture of the fiber bodies 111 and the binding materials 115. The zero-valent iron particles 117 are powders having an average particle diameter of 0.01 to 100 μm on a volume basis. An amount of the zero-valent iron particles 117 added is 1 mass % or more and 10 mass % or less in terms of the mass ratio of the anode electrode 11. The addition of the zero-valent iron particles 117 reduces the electric resistance of the anode electrode 11 and improves the electrical properties. The zero-valent iron particles 117 correspond to an example of metal particles. The anode electrode 11 shown in FIG. 3 includes the zero-valent iron particles 117, and is not limited thereto. The material is not limited as long as the material reduces the electric resistance of the anode electrode 11.

The anode electrode 11 preferably contains the zero-valent iron particles 117.

Since the anode electrode 11 contains the zero-valent iron particles 117, the electric resistance of the anode electrode 11 further deteriorates.

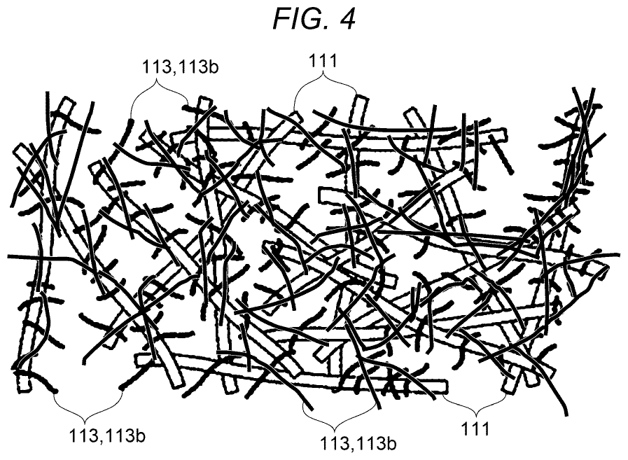

FIG. 4 shows an example of the configuration of the anode electrode 11. FIG. 4 schematically shows an enlarged configuration of a part of the anode electrode 11. The anode electrode 11 shown in FIG. 4 includes the fiber bodies 111, a conductive fiber 113b as an example of the conductive material 113, and the binding materials 115. The anode electrode 11 shown in FIG. 4 has a configuration same as that of the anode electrode 11 shown in FIG. 2 except that the conductive fiber 113b is included instead of the conductive powder 113a. FIG. 4 shows the anode electrode 11 from which the binding material 115 is omitted.

The conductive fiber 113b has conductivity. The conductive fiber 113b contributes to the conductivity of the anode electrode 11. The conductive fiber 113b is bonded to the surface of the fiber body 111 by the binding material 115. A plurality of conductive fibers 113b are in contact with each other and bonded onto the fiber body 111. The plurality of conductive fibers 113b are disposed in contact with each other, thereby imparting the conductivity to the fiber body 111.

The conductive fiber 113b is made of a carbon fiber. The carbon fiber is produced by cutting a polyacrylonitrile (PAN)-based carbon fiber and a pitch-based carbon fiber. The PAN-based carbon fiber is obtained by carbonizing a PAN precursor. The pitch-based carbon fiber is obtained by carbonizing a pitch fiber made of coal tar or heavy petroleum fractions as a raw material. The conductive fibers 113b have an average fiber diameter of 5 μm to 30 μm and an average fiber length of 0.05 mm to 0.1 mm. A fiber diameter and a fiber length of the conductive fiber 113b are smaller than the fiber diameter and the fiber length of the fiber body 111. The conductive fiber 113b may be made of one or a plurality of types of carbon fibers. The material of the conductive fiber 113b is not limited as long as the conductive fiber 113b has a property of imparting the conductivity to the fiber body 111.

The anode electrode 11 is produced using the fiber bodies 111, the conductive fibers 113b, and the binding materials 115. A producer mixes the fiber bodies 111 and the binding materials 115 at a predetermined mass ratio to produce a mixture. In the mixture, the binding materials 115 adhere to the surfaces of the fiber bodies 111. After producing the mixture, the producer adds the conductive fiber 113b to the mixture and mixes them again. The producer generates an electrode mixture including the fiber body 111, the conductive fiber 113b, and the binding material 115. The producer applies heat and pressure to the electrode mixture in a predetermined mold to produce a solid body. The applied pressure is in a range of 1 kN/mm² or more and 20 kN/mm² or less. A heating temperature is in a range of 80° C. or higher and 150° C. or lower. The applied pressure and the heating temperature are appropriately adjusted according to addition amounts of the conductive fiber 113b and the binding material 115. The producer processes the solid body into a desired shape to produce the anode electrode 11. The anode electrode 11 is a compact including holes.

The anode electrode 11 shown in FIG. 4 may contain the zero-valent iron particles 117. The zero-valent iron particles 117 are added when the conductive fiber 113b are mixed into the mixture of the fiber bodies 111 and the binding materials 115.

The anode electrode 11 shown in FIG. 4 includes carbon fibers as the conductive fibers 113b, and is not limited thereto. The anode electrode 11 shown in FIG. 4 may contain the conductive powder 113a such as graphite particles. The anode electrode 11 preferably includes at least one of the conductive fiber 113b and the conductive powder 113a.

Since the anode electrode 11 contains at least one of the conductive fiber 113b and the conductive powder 113a, the electric resistance of the anode electrode 11 deteriorates.

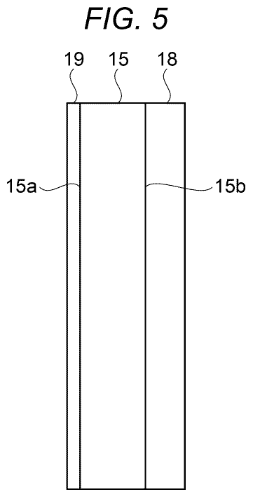

FIG. 5 shows a schematic configuration of the cathode electrode 15. The cathode electrode 15 has the ion exchange surface 15a and the oxygen-permeable surface 15b. The cathode electrode 15 includes a water-repellent layer 18 and a filter layer 19.

The cathode electrode 15 has conductivity and oxygen permeability. The cathode electrode 15 is formed of a carbon fiber sheet or the like. The cathode electrode 15 may include non-conductive fibers 151, carbon-based materials 153, and fixing materials 155.

The ion exchange surface 15a is a surface facing the PEM 13. The ion exchange surface 15a is in contact with the PEM 13 directly or via the filter layer 19. Hydrogen ions react with oxygen on the ion exchange surface 15a or in the vicinity of the ion exchange surface 15a.

The oxygen-permeable surface 15b is a surface that comes into contact with an atmosphere directly or via the water-repellent layer 18. The oxygen-permeable surface 15b allows oxygen in the atmosphere to permeate into the cathode electrode 15.

The water-repellent layer 18 is disposed on the oxygen-permeable surface 15b of the cathode electrode 15. The water-repellent layer 18 has oxygen permeability and water repellency. The water-repellent layer 18 allows oxygen in the atmosphere to permeate through the cathode electrode 15. The water-repellent layer 18 prevents the organic wastewater L from adhering to the cathode electrode 15. The water-repellent layer 18 is made of a nonwoven fabric such as polyethylene or polypropylene, a film such as polytetrafluoroethylene (PTFE), a composite material film in which a polyurethane polymer or the like is combined, beeswax, or the like. Since the water-repellent layer 18 is made of beeswax as an example, the environmental load at the time of producing the cathode electrode 15 is reduced.

The cathode electrode 15 preferably includes the water-repellent layer 18 disposed on the oxygen-permeable surface 15b different from the ion exchange surface 15a in contact with the PEM 13.

By providing the water-repellent layer 18, the cathode electrode 15 can efficiently permeate oxygen while preventing adhesion of the organic wastewater L.

The water-repellent layer 18 is preferably made of beeswax.

Since the water-repellent layer 18 is made of beeswax, the environmental load can be reduced while maintaining the water repellency and the oxygen permeability.

The filter layer 19 is disposed on the ion exchange surface 15a of the cathode electrode 15. The filter layer 19 is disposed between the PEM 13 and the cathode electrode 15. The filter layer 19 prevents the microorganism from entering the cathode electrode 15. The filter layer 19 may or may not be disposed on the ion exchange surface 15a of the cathode electrode 15. The filter layer 19 is appropriately disposed.

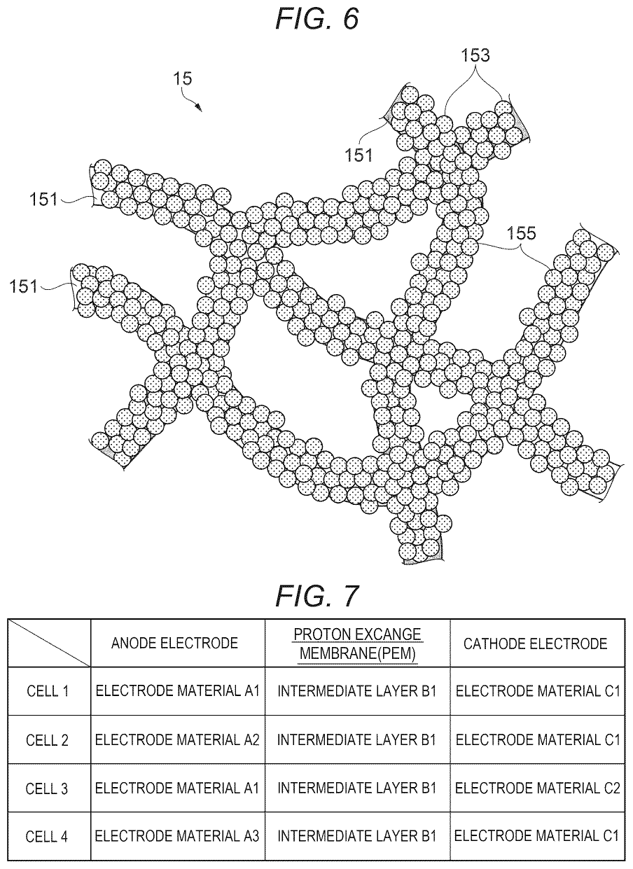

FIG. 6 shows an example of the configuration of the cathode electrode 15. FIG. 6 schematically shows an enlarged configuration of a part of the cathode electrode 15. FIG. 6 shows the cathode electrode 15 formed of the non-conductive fibers 151, the carbon-based materials 153, and the fixing materials 155. The cathode electrode 15 may contain a material other than the non-conductive fibers 151, the carbon-based material 153, and the fixing materials 155. The cathode electrode 15 corresponds to an example of a electrodes for MFCs.

The non-conductive fibers 151 are made of a non-conductive material. The non-conductive fibers 151 support the carbon-based materials 153. Since the cathode electrode 15 includes the non-conductive fibers 151, the number of holes in the cathode electrode 15 increases. As the number of holes increases, a surface area of the cathode electrode 15 increases. When the surface area of the cathode electrode 15 increases, the number of sites where an oxidation-reduction reaction using oxygen occurs increases. The non-conductive fiber 151 is, for example, a defibrated fiber defibrated by a dry fiber technology. The non-conductive fiber 151 has a fiber diameter of 5 μm to 100 μm and a fiber length of 10 μm to 1000 μm. A plurality of non-conductive fibers 151 are bonded to each other by the fixing material 155. The non-conductive fiber 151 may be made of the same material as the fiber body 111 or may be made of a different material. The non-conductive fibers 151 are preferably made of the same material as the fiber body 111. The non-conductive fiber 151 can be made of a common material with the fiber body 111. The non-conductive fiber 151 corresponds to an example of a fiber and a fiber base material.

The carbon-based material 153 has conductivity. The carbon-based material 153 contributes to the conductivity of the cathode electrode 15. The carbon-based material 153 is fixed to a surface of the non-conductive fiber 151 by the fixing material 155. A plurality of carbon-based materials 153 are in contact with each other and fixed on the non-conductive fibers 151. The plurality of carbon-based materials 153 are disposed in contact with each other, thereby imparting the conductivity to the non-conductive fibers 151. The carbon-based material 153 is disposed in a single layer or a multiple layer on the non-conductive fibers 151. The carbon-based material 153 is preferably disposed in a multiple layer on the non-conductive fibers 151.

The carbon-based material 153 is formed of a carbon powder such as graphite particles or carbon black particles. The carbon-based material 153 is a powder having an average particle diameter of 0.1 μm to 100 μm on a volume basis. The carbon-based material 153 is formed of one or a plurality of types of carbon powder. The material of the carbon-based material 153 is not limited as long as the carbon-based material 153 has a property of imparting the conductivity to the non-conductive fibers 151. The carbon-based material 153 corresponds to an example of a conductive material and a conductivity imparting material.

The carbon-based material 153 may be formed of a carbon fiber. The carbon fiber is produced by cutting the PAN-based carbon fiber and the pitch-based carbon fiber. The size of the carbon fibers is an average fiber diameter of 5 μm to 30 μm and an average fiber length of 0.05 mm to 0.1 mm. The fiber diameter and the fiber length of the carbon-based material 153 are smaller than the fiber diameter and the fiber length of the non-conductive fiber 151. The carbon-based material 153 may be made of one or a plurality of types of carbon fibers. The carbon-based material 153 may be a mixture of the carbon powder and the carbon fiber.

The carbon-based material 153 may be the same material as the conductive powder 113a, or may be a different material. The carbon-based material 153 may be the same material as the conductive fiber 113b, or may be a different material. The carbon-based material 153 is preferably the same material as the conductive powder 113a or the conductive fiber 113b. Since the carbon-based material 153 is the same material as the conductive powder 113a or the conductive fiber 113b, the anode electrode 11 and the cathode electrode 15 can have the same basic material configuration.

The content of the carbon-based material 153 is preferably 50 mass % or more and 80 mass % or less in terms of the mass ratio of the cathode electrode 15. When the content of the carbon-based material 153 is less than 50 mass %, the electric resistance of the cathode electrode 15 increases, and the function as the electrode deteriorates. When the content of the carbon-based material 153 is more than 80 mass %, holes in the cathode electrode 15 are reduced, and the oxygen permeability is reduced.

The fixing material 155 fixes the carbon-based material 153 to the non-conductive fibers 151. The carbon-based material 153 is fixed to the surface of the non-conductive fiber 151 by the fixing material 155. The fixing material 155 fixes the plurality of non-conductive fibers 151 to each other. The plurality of non-conductive fibers 151 are fixed to each other by the fixing material 155. The fixing material 155 fixes the plurality of carbon-based materials 153 to each other. Due to the fixing material 155, the plurality of carbon-based materials 153 are formed in one or more layers on the non-conductive fibers 151.

The material of the fixing material 155 is not limited as long as the fixing material 155 can fix the non-conductive fibers 151 and the carbon-based material 153. The fixing material 155 may be a solid material or a liquid material at a room temperature. The fixing material 155 preferably contains at least one of calcium carbonate, a lignin powder (average particle diameter of 26 μm to 70 μm on a volume basis), and a starch powder (average particle diameter of 1 μm to 30 μm on a volume basis). When the fixing material 155 contains at least one of the calcium carbonate, the lignin powder, and the starch powder, an environmental load when the cathode electrode 15 is generated is reduced. The fixing material 155 may be a waxy substance produced from resource organisms such as scale insects. The fixing material 155 corresponds to an example of the binder and a fixing agent.

The fixing material 155 may be the same material as the binding material 115, or may be a different material. The fixing material 155 is preferably the same material as the binding material 115. Since the fixing material 155 is the same material as the binding material 115, the environmental load at the time of producing the cathode electrode 15 is reduced.

The content of the fixing material 155 is preferably 5 mass % or more and 30 mass % or less in terms of the mass ratio of the cathode electrode 15. When the content of the fixing material 155 is less than 5 mass %, a fixing force of the carbon-based material 153 fixed on the non-conductive fibers 151 decreases. It is difficult to maintain the shape of the cathode electrode 15. When the content of the fixing material 155 is more than 30 mass %, the fixing material 155 disposed between the plurality of carbon-based materials 153 increases, and the electric resistance increases. Electrical properties of the cathode electrode 15 deteriorate.

The cathode electrode 15 preferably contains the non-conductive fibers 151, the carbon-based materials 153 having conductivity, and the fixing materials 155 for fixing the carbon-based materials 153 to the non-conductive fibers 151.

Since the cathode electrode 15 includes the non-conductive fibers 151, the carbon-based materials 153, and the fixing materials 155, the environmental load at the time of producing the cathode electrode 15 is reduced.

The content of the non-conductive fibers 151 in the cathode electrode 15 is a remaining amount excluding the carbon-based materials 153 and the fixing materials 155. The cathode electrode 15 may contain an additive other than the non-conductive fibers 151, the carbon-based materials 153, and the fixing materials 155. When the cathode electrode 15 contains an additive other than the non-conductive fibers 151, the carbon-based materials 153, and the fixing materials 155, the content of the non-conductive fibers 151 in the cathode electrode 15 is the remaining amount excluding the carbon-based materials 153, the fixing materials 155, and the additive.

The cathode electrode 15 is formed using the non-conductive fibers 151, the carbon-based materials 153, and the fixing materials 155. The producer mixes the non-conductive fibers 151 and the fixing materials 155 at a predetermined mass ratio to produce a mixture. In the mixture, the fixing materials 155 adhere to the surface of the non-conductive fibers 151. After producing the mixture, the producer adds the carbon-based material 153 to the mixture and mixes them again. The producer generates a cathode electrode mixture including the non-conductive fibers 151, the carbon-based materials 153, and the fixing materials 155. The producer applies heat and pressure to the cathode electrode mixture in a predetermined mold to produce a solid body. The applied pressure is in a range of 1 kN/mm² or more and 20 kN/mm² or less. A heating temperature is in a range of 80° C. or higher and 150° C. or lower. The applied pressure and the heating temperature are appropriately adjusted according to addition amounts of the carbon-based material 153 and the fixing material 155. The producer processes the solid body into a desired shape to produce the cathode electrode 15. The cathode electrode 15 is a compact including holes.

The MFC 10, which comes into contact with the organic wastewater L containing organic substances and microorganisms, includes the anode electrode 11 including the non-conductive fiber body 111, the conductive material 113 having conductivity, and the binding material 115 for binding the conductive material 113 to the fiber body 111, and the cathode electrode 15 having conductivity.

Since the anode electrode 11 includes the fiber bodies 111, the conductive materials 113, and the binding materials 115, the number of sites where electrons are moved by the microorganism increases. The performance of the MFC 10 is improved.

The MFC system 100 includes: the MFC 10 having the anode electrode 11 in contact with the organic wastewater L containing an organic substance and a microorganism, the cathode electrode 15 to which oxygen is supplied, and the PEM 13 disposed between the anode electrode 11 and the cathode electrode 15, and the resistor 31 coupled to the anode electrode 11 and the cathode electrode 15. The anode electrode 11 includes the non-conductive fiber bodies 111, the conductive materials 113 having conductivity, and the binding materials 115 that bonds the conductive materials 113 to the fiber bodies 111.

Decomposition of the organic substance by the microorganism is promoted. Purification capacity of the organic wastewater L by the MFC system 100 is improved.

### Example 1

In Example 1, the MFC 10 including the anode electrode 11 including the fiber body 111, the conductive material 113, and the binding material 115 is produced. The MFC 10 produced in Example 1 is referred to as a cell 1.

The anode electrode 11 is formed using the fiber body 111, the conductive material 113, and the binding material 115. First, a mixture containing the fiber body 111 and the binding material 115 is prepared. For the fiber body 111, a vegetable fiber made of eucalyptus plant is used. For the binding material 115, a scale insect secretion is used. The scale insect secretion is a waxy substance. A mixing ratio of the plant fiber is 80 mass %, and a mixing ratio of the scale insect secretion is 20 mass %. A planetary ball mill is used to mix the plant fiber and the scale insect secretion to prepare a mixture.

After the mixture is prepared, the conductive material 113 is mixed with the mixture. The conductive material 113 is a chopped carbon fiber, K223HM, manufactured by Mitsubishi Chemical Corporation. The chopped carbon fiber is an example of the carbon fiber. The mixing ratio of the mixture is 35 mass %, and the mixing ratio of the chopped carbon fiber is 65 mass %. The chopped carbon fiber is a short fiber having a fiber diameter of 11 μm and a fiber length of 0.05 mm. The mixture and the chopped carbon fiber are mixed by a planetary ball mill to produce an anode electrode mixture. The anode electrode mixture is a mixture of 28 mass % of the plant fiber, 7 mass % of the scale insect secretion, and 65 mass % of the chopped carbon fiber.

After the anode electrode mixture is prepared, the anode electrode mixture is heated and pressurized to prepare a sheet material. The anode electrode mixture is heated to 120° C. by a heater. The anode electrode mixture is heated and then pressurized by a pressing machine at a pressure of 5 kN/mm². The anode electrode mixture is formed into an electrode sheet having a thickness of 0.8 mm.

The electrode sheet is processed into a predetermined size after being formed. The electrode sheet is processed into a rectangular piece having a width of 20 mm and a length of 30 mm. A plurality of rectangular pieces are bonded to form the anode electrode 11 having a quadrangular prism shape. The formed anode electrode 11 is referred to as an electrode material A1.

An ion exchange resin is used for the PEM 13. As the ion exchange resin, NAFION manufactured by DuPont is used. A NAFION membrane having a thickness of 0.5 mm is disposed on an inner peripheral surface of the anode electrode 11. The PEM 13 of the NAFION membrane is referred to as an intermediate layer B1.

The cathode electrode 15 is made of a graphite felt manufactured by Nippon Carbon Co., Ltd. The graphite felt is a carbon-based fiber. The graphite felt is disposed on the inner peripheral surface of the PEM 13. A PTFE membrane is disposed as the water-repellent layer 18 on the inner peripheral surface of the graphite felt. The PTFE membrane is formed by immersing one surface of the graphite felt in a PTFE solution. The cathode electrode 15 of the graphite felt is represented as an electrode material C1.

The cell 1 is produced by combining the electrode material A1, the intermediate layer B1, and the electrode material C1. The cell 1 is disposed in the organic wastewater L. The organic wastewater L is lake water collected from the shore of Lake Suwa. The organic wastewater L contains organic mud and electrochemically active bacteria. The electrochemically active bacteria are bacteria of the genus Geobacter.

### Example 2

In Example 2, the MFC 10 including the anode electrode 11 including the fiber body 111, the conductive material 113, the zero-valent iron particles 117, and the binding material 115 is produced. The MFC 10 produced in Example 2 is referred to as a cell 2.

The anode electrode 11 is formed using the fiber body 111, the conductive material 113, the zero-valent iron particles 117, and the binding material 115. First, a mixture containing the fiber body 111 and the binding material 115 is prepared. For the fiber body 111, a vegetable fiber made of eucalyptus plant is used. The binding material 115 is a lignin powder called Sunex P321 manufactured by Nippon Paper Industries Co., Ltd. Sunex is a registered trademark. The mixing ratio of the plant fiber is 75 mass %, and the mixing ratio of the lignin powder is 25 mass %. A planetary ball mill is used to mix the plant fiber and the lignin powder to prepare a mixture.

After the mixture is prepared, the conductive material 113 and the zero-valent iron particles 117 are mixed with the mixture. The conductive material 113 is made of graphite particles manufactured by Nishimura Graphite Co., Ltd. The graphite particles are an example of the carbon powder. The graphite powder is a scaly powder having an average particle diameter of 500 μm on a volume basis. The zero-valent iron particles 117 are made of an iron powder manufactured by Fujifilm Wako Pure Chemical Industries, Ltd. The iron powder has an average particle diameter of 40 μm or less on a volume basis. The mixing ratio of the mixture is 30 mass %, the mixing ratio of the graphite powder is 65 mass %, and the mixing ratio of the iron powder is 5 mass %. The mixture, the graphite particles, and the iron powder are mixed by a planetary ball mill to prepare an anode electrode mixture. The anode electrode mixture is a mixture of 22.5 mass % of the plant fiber, 7.5 mass % of the lignin powder, 65.0 mass % of the graphite particles, and 5.0 mass % of the iron powder.

The anode electrode mixture is produced and then heated and pressurized to produce a sheet material. The anode electrode mixture is heated to 130° C. by a heater. The anode electrode mixture is heated and then pressurized by a pressing machine at a pressure of 10 kN/mm². The anode electrode mixture is formed into an electrode sheet having a thickness of 1.0 mm.

The electrode sheet is processed into a predetermined size after being formed. The electrode sheet is processed into a rectangular piece having a width of 20 mm and a length of 30 mm. A plurality of rectangular pieces are bonded to form the anode electrode 11 having a quadrangular prism shape. The formed anode electrode 11 is referred to as an electrode material A2.

The cell 2 is produced using the electrode material A2. The intermediate layer B1 is used for the PEM 13. The electrode material C1 is used for the cathode electrode 15. The cell 2 is produced by combining the electrode material A2, the intermediate layer B1, and the electrode material C1. The cell 2 is disposed in the organic wastewater L. The organic wastewater L is lake water collected from the shore of Lake Suwa. The organic wastewater L contains organic mud and electrochemically active bacteria. The electrochemically active bacteria are bacteria of the genus Geobacter.

### Example 3

In Example 3, the MFC 10 including the anode electrode 11 including the fiber body 111, the conductive material 113, and the binding material 115 is produced. The MFC 10 produced in Example 3 is referred to as a cell 3.

The electrode material A1 is used for the anode electrode 11. The intermediate layer B1 is used for the PEM 13. The cathode electrode 15 is formed using the non-conductive fibers 151, the carbon-based materials 153, and the fixing materials 155. The cathode electrode 15 includes the water-repellent layer 18 made of beeswax.

The cathode electrode 15 is formed using the non-conductive fibers 151, the carbon-based materials 153, and the fixing materials 155. First, a mixture containing the non-conductive fibers 151 and the carbon-based materials 153 is prepared. For the non-conductive fibers 151, a cellulose fiber made of recycled paper is used. The fixing material 155 is a lignin powder called Sunex P321 manufactured by Nippon Paper Industries Co., Ltd. The mixture ratio of the cellulose fiber is 75 mass %, and the mixture ratio of the lignin powder is 25 mass %. A planetary ball mill is used to mix the cellulose fiber and the lignin powder to prepare a mixture.

After the mixture is prepared, the carbon-based materials 153 are mixed into the mixture. The carbon-based material 153 are graphite particles manufactured by Nishimura Graphite Co., Ltd. The graphite particles are an example of the carbon powder. The graphite powder is a scaly powder having an average particle diameter of 500 μm on a volume basis. The mixing ratio of the mixture is 30 mass %, and the mixture ratio of the graphite powder is 70 mass %. The mixture and the graphite particles are mixed by a planetary ball mill to prepare a cathode electrode mixture. The cathode electrode mixture is a mixture of 22.5 mass % of the cellulose fiber, 7.5 mass % of the lignin powder, and 70.0 mass % of the graphite particles.

The cathode electrode mixture is produced and then heated and pressurized to produce a sheet material. The cathode electrode mixture is heated to 130° C. by a heater. The cathode electrode mixture is heated and then pressurized by a pressing machine at a pressure of 10 kN/mm². The cathode electrode mixture is formed into an electrode sheet having a thickness of 1.0 mm.

The electrode sheet is processed into a predetermined size after being formed. The electrode sheet is processed into a rectangular piece having a width of 20 mm and a length of 30 mm. A plurality of rectangular pieces are bonded to form the cathode electrode 15 having a quadrangular prism shape.

The water-repellent layer 18 provided on the cathode electrode 15 is made of beeswax manufactured by Miki Chemical Industry Co., Ltd. The beeswax is applied to the oxygen-permeable surface 15b of the cathode electrode 15. The applied beeswax layer functions as the water-repellent layer 18. The cathode electrode 15 with the beeswax layer is represented as an electrode material C2.

The cell 3 is produced by combining the electrode material A1, the intermediate layer B1, and the electrode material C2. The cell 3 is disposed in the organic wastewater L. The organic wastewater L is lake water collected from the shore of Lake Suwa. The organic wastewater L contains organic mud and electrochemically active bacteria. The electrochemically active bacteria are bacteria of the genus Geobacter.

### Comparative Example 1

In Comparative Example 1, the MFC 10 including the anode electrode 11 made of carbon cloth, which is a carbon fiber, and the cathode electrode 15 made of the graphite felt is produced. The MFC 10 produced in Comparative Example 1 is referred to as a cell 4.

The anode electrode 11 is made of carbon cloth manufactured by Toray Industries, Inc. The thickness of the carbon cloth is 100 μm. The anode electrode 11 using the carbon cloth is referred to as an electrode material A3.

The cell 4 is produced by combining the electrode material A3, the intermediate layer B1, and the electrode material C1. The cell 4 is disposed in the organic wastewater L. The organic wastewater L is lake water collected from the shore of Lake Suwa. The organic wastewater L contains organic mud and electrochemically active bacteria. The electrochemically active bacteria are bacteria of the genus Geobacter.

FIG. 7 shows the configuration of each MFC 10. FIG. 7 shows the configurations of the cell 1, the cell 2, the cell 3, and the cell 4, which are the MFCs 10. The cell 1, the cell 2, and the cell 3 are the configurations of the MFCs 10 produced in Examples 1, 2, and 3, respectively. The cell 4 has the configuration of the MFC 10 produced in Comparative Example 1.

### Evaluation Result

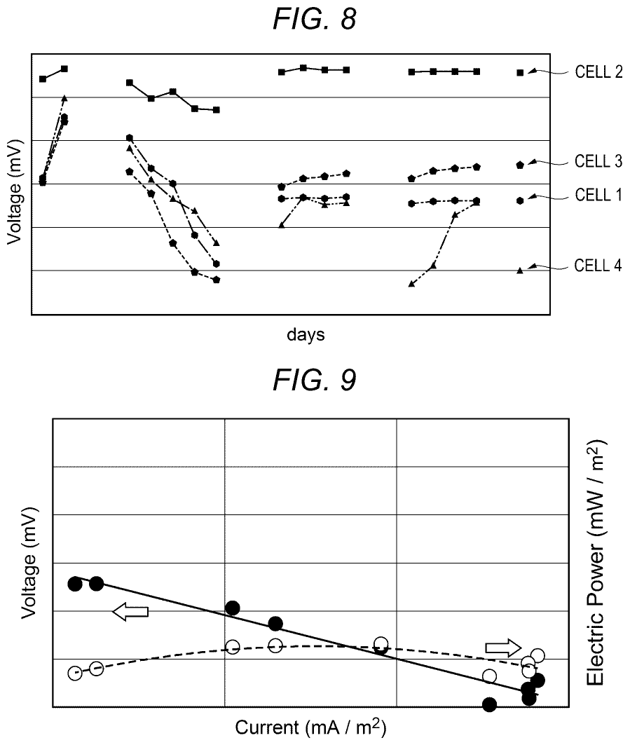

FIG. 8 shows an example of evaluation results of the MFC 10. FIG. 8 shows a temporal change in generated voltages of the MFC 10. FIG. 8 shows the temporal changes in the generated voltages of the cells 1, 2, 3, and 4. A horizontal axis represents elapse of days. A vertical axis represents the generated voltage.

As shown in FIG. 8, the generated voltages of the cell 1, the cell 3, and the cell 4 at an initial stage of the beginning of measurement are substantially equal values. With the elapse of days, the generated voltage of the cell 4, which is the comparative example, decreases. In the cell 1, the cell 2, and the cell 3 according to the embodiment, the decrease in the generated voltage with the lapse of days is prevented. The generated voltage remains at a constant value.

The generated voltage by the cell 2 including the zero-valent iron particles 117 is higher than the generated voltages by the cells 1, 3, and 4. In the cell 2, a decrease in the generated voltage due to the lapse of days is prevented. The inclusion of the zero-valent iron particles 117 improves cell characteristics.

The generated voltage by the cell 3 having the water-repellent layer 118 made of beeswax remains higher than the generated voltage by the cell 1 having the water-repellent layer 118 made of PTFE after the elapse of a predetermined number of days. The use of beeswax for the water-repellent layer 118 improves the cell characteristics.

FIGS. 9, 10, 11, and 12 show examples of the evaluation results of the MFC 10. FIGS. 9, 10, 11, and 12 show polarization analysis results of the MFC 10. FIGS. 9, 10, 11, and 12 show current-voltage characteristics of the MFC 10 and a relationship between a current and electric power. FIGS. 9, 10, 11, and 12 show the current-voltage characteristics and the relationship between the current and the electric power after the elapse of 12 days from the start of evaluation of the MFC 10. Current and voltage measurement is performed by changing a resistance value of the resistor 31 coupled to the MFC 10.

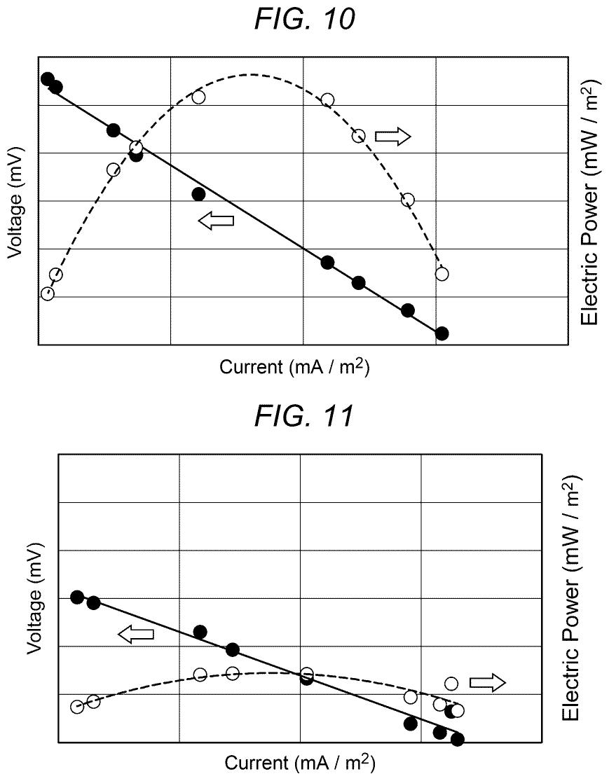

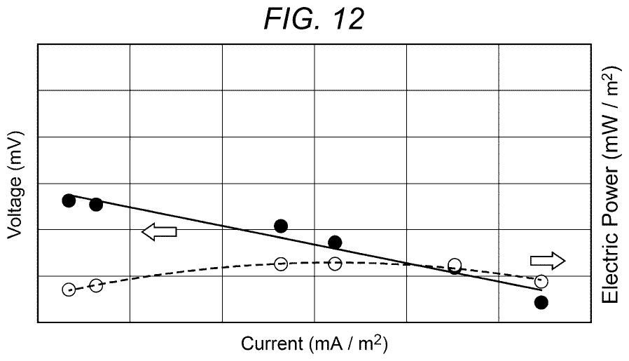

FIG. 9 shows the current-voltage characteristics of the cell 1 and the relationship between the current and the electric power. FIG. 10 shows the current-voltage characteristics of the cell 2 and the relationship between the current and the electric power. FIG. 11 shows the current-voltage characteristics of the cell 3 and the relationship between the current and the electric power. FIG. 12 shows the current-voltage characteristics of the cell 4 and the relationship between the current and the electric power.

As shown in FIGS. 9, 10, 11, and 12, a maximum power value, which is a peak value of the electric power, differs depending on the cell. The maximum power values of the cells 1, 2, and 3 are higher than the maximum power value of the cell 4. The use of the anode electrode 11 including the fiber body 111, the conductive material 113, and the binding material 115 improves the characteristics of the MFC 10.

The maximum power value of the cell 2 is higher than the maximum power values of the cell 1 and the cell 3. The addition of the zero-valent iron particles 117 to the anode electrode 11 improves the characteristics of the MFC 10. The maximum power value of the cell 3 is higher than the maximum power value of the cell 4. The use of beeswax in the water-repellent layer 18 improves the characteristics of the MFC 10.

What is claimed is:

1. A electrodes for MFCs comprising:
a non-conductive fiber;
a conductive material having conductivity; and
a binder configured to bind the conductive material to the fiber.

2. The electrodes for MFCs according to claim 1, wherein
the conductive material is at least one of a carbon fiber and graphite particles.

3. The electrodes for MFCs according to claim 2, further comprising:
metal particles having conductivity.

4. The electrodes for MFCs according to claim 1, wherein
the binder contains at least one of calcium carbonate, a lignin powder, and a starch powder.

5. A MFC to be in contact with a liquid containing an organic substance and an electrochemically active bacterium, the MFC comprising:
an anode electrode containing a non-conductive fiber, a conductive material having conductivity, and a binder for binding the conductive material to the fiber; and
a cathode electrode having conductivity.

6. The MFC according to claim 5, wherein
the cathode electrode contains a non-conductive fiber base material, a conductivity imparting material having conductivity, and a fixing agent for fixing the conductivity imparting material to the fiber base material.

7. The MFC according to claim 6, wherein
the cathode electrode includes a water-repellent layer.

8. The MFC according to claim 7, wherein
the water-repellent layer is made of beeswax.

9. The MFC according to claim 5, wherein
the anode electrode contains metal particles having conductivity.

10. The MFC according to claim 5, further comprising:
an PEM containing a non-conductive fiber material, wood powder particles, and an adhesive for bonding the fiber material to the wood powder particles, and provided between the cathode electrode and the anode electrode in contact with the cathode electrode and the anode electrode.

11. A MFC system comprising:
a MFC including an anode electrode to be in contact with a liquid containing an organic substance and an electrochemically active bacterium, a cathode electrode to which oxygen is supplied, and an PEM disposed between the anode electrode and the cathode electrode; and
a resistor coupled to the anode electrode and the cathode electrode, wherein
the anode electrode contains a non-conductive fiber, a conductive material having conductivity, and a binder configured to bind the conductive material to the fiber.
